(19) United States
(12) Patent Application Publication
(10) Pub. No.: US 2009/0021173 A1
(43) Pub. Date: Jan. 22, 2009

(54) Carrier element on which an Hg containing material for application in a discharge lamp is formed, and discharge lamp with such a carrier element

(75) Inventors: Christian Harzig, Mering (DE); Erolf Weinhardt, Diedorf (DE)

Correspondence Address: OSRAM SYLVANIA INC, 100 ENDICOTT STREET, DANVERS, MA, 01923, US

(73) Assignee: OSRAM GESELLSCHAFT MIT BESCHRANKTER HAFTUNG, MUNCHEN (DE)

(21) Appl. No.: 12/219,340

(22) Filed: Jul. 21, 2008

(30) Foreign Application Priority Data
Jul. 20, 2007 (DE) 10 2007 033 879.3

(51) Int. Cl. H01J 61/20

(52) U.S. Cl. 313/639

(57) ABSTRACT

Carrier element on which an Hg-containing material for application in a discharge lamp is formed, and discharge lamp with such a carrier element

The invention relates to a carrier element on which an Hg-containing material for application in a discharge lamp (1) is formed, the Hg-containing material being in the form of a bar-shaped element (12) and being arranged on a holder (14, 15, 16, 17; 19) of the carrier element (11). The invention also relates to a discharge lamp of such a carrier element.

### TECHNICAL FIELD

The invention relates to a carrier element on which an Hg-containing material for application in a discharge lamp is formed, and to a discharge lamp with such a carrier element.

### PRIOR ART

The introduction of mercury into discharge lamps, in particular low-pressure discharge lamps, is known and can take place, for example, using a metal strip which is provided with a corresponding coating. WO 98/14983 has disclosed a low-pressure discharge lamp in which a carrier element, which is in the form of a type of plate, is arranged in a discharge vessel of the lamp and in particular is fastened, for example, on an electrode frame. The surface of the carrier element is coated and the carrier element has firstly a coating with an Hg-containing material and secondly a coating with a getter material. The two coatings are formed separately from one another. The carrier element can be a substantially planar plate, but may also be a bent plate.

Conventionally, such a surface coating is carried out using a screw-type vibration system, with a corresponding powder being applied to the carrier element and distributed for this purpose. This procedure makes the metering accuracy entirely dependent on the metering system and relatively inaccurate. As a result, the mercury concentration fluctuates, which means that the functionality of the discharge lamp can be impaired.

### DESCRIPTION OF THE INVENTION

The object of the present invention is to provide a carrier element with which the metering of the Hg-containing material can be improved. In particular, it is also an object to provide such a production method for a carrier element. Likewise, a discharge lamp with a carrier element is intended to be provided in which the functionality can be improved by more precise and accurate setting of the quantity of mercury.

This object is achieved by a carrier element which has the features as claimed in claim 1 and a discharge lamp which has the features as claimed in claim 15.

A carrier element according to the invention is formed for application in a discharge lamp. An Hg-containing material is arranged on the carrier element. This Hg-containing material is in the form of a bar-shaped element and is arranged in a holder of the carrier element. By means of such a configuration, simple and uncomplex application of the Hg-containing material can be achieved and, moreover, a very precise and reproducible quantity of mercury per carrier element can be metered. In particular, very small quantities of mercury can be metered precisely.

Preferably, the bar-shaped element is designed in such a way that it has a defined quantity of mercury per unit length and the quantity of mercury to be applied specifically to the carrier element can be metered depending on the length of the element. As a result, it is possible in a very simple and quickly comprehensible way for the mercury concentration to be set and comprehended since only a desired length of the element needs to be used in order to be able to provide the carrier element with a desired mercury concentration.

Preferably, the bar-shaped element has a mercury concentration of 0.46 mg per millimeter. In particular, in this case a wire with a corresponding definition of the quantity of mercury per unit length given a specific diameter is provided as the bar-shaped element. This mercury concentration per unit length is preferable, but merely by way of example, and it is also possible for any other desired concentrations per unit length to be provided. In particular, this concentration can also be configured in another way depending on the cross section and therefore also depending on the volume, when considered over the unit length, of the bar-shaped element.

As a result of a concentration ratio of mercury to unit length of the bar-shaped element as mentioned as being preferable above, a quantity of mercury of less than 2 mg can also be metered very precisely, in this regard lengths in the region of 4 mm of the bar-shaped element being produced and being associated with the carrier element.

Preferably, the carrier element has, as the holder, at least one depression, in which the element is arranged. For example, a groove or a trench or else even a formation in the manner of a blind hole can be provided as the depression. Preferably, in this case the carrier element is in the form of a type of plate and the depression is formed into this plate-like part.

It can also be provided that the carrier element is a tubular hollow body. Preferably, at least one holding lug for holding the bar-shaped element is formed on the outer side of such a hollow body. Preferably, the bar-shaped element is adhesively bonded, clamped or welded into the holding lug. This represents a very simple fastening option, which nevertheless ensures sufficiently secure positioning of the bar-shaped element.

Preferably, the holding lug extends substantially over the entire length of the bar-shaped element. Given such a configuration, the bar-shaped element is arranged in the interior of the holding lug, with the holding lug substantially completely surrounding the bar-shaped element circumferentially. As a result, the bar-shaped element can also be protected.

It has proven to be particularly preferable if the tubular hollow body surrounds an electrode arranged in the discharge vessel of the discharge lamp. The configuration of a carrier element which is then also referred to as a dome is arranged in such a way that the axis of rotation or longitudinal axis of the hollow body is arranged parallel or coaxially with respect to the longitudinal axis of the electrode. Such a carrier element is designed to be multifunctional.

It can also be provided that the carrier element is arranged on a power supply line for an electrode. This power supply line is associated with an electrode frame and is used for holding the electrode in the discharge space. In addition to the configuration of the carrier element as a tubular hollow body for engaging around an electrode or an application of the carrier element on a power supply line, it can also be provided that the carrier element is arranged on a central support, which is associated with an electrode frame and which is designed for holding a tubular hollow body surrounding the electrode. In this configuration, the carrier element is therefore not at the same time also the tubular hollow body, but a separate component part from this, which is arranged on the central support.

Preferably, the carrier element is in the form of a metal strip. The plate-like structure of the metal strip can be substantially planar or else angular.

Preferably, the bar-shaped element has a sheath and a core, the mercury being contained exclusively in the core. The mercury in the bar-shaped element is therefore enveloped by the sheath material. The metered quantity of the pulverulent mercury material in the interior (in the core) of the bar-shaped element, in particular of the wire, is reproducible, very precise and in particular only dependent on the length. In particular metered quantities of less than 1 mg can thus be realized very precisely.

The carrier element is fastened in the interior of the discharge space of the discharge vessel and, during operation of the discharge lamp, the carrier element is heated at a high frequency, as a result of which the corresponding quantity of mercury is then released.

A further aspect of the invention relates to a discharge lamp, in particular to a low-pressure discharge lamp, with a discharge vessel and at least one electrode arranged therein, and with a carrier element according to the invention or an advantageous configuration thereof. The carrier element is arranged in particular on an electrode frame. The electrode frame comprises at least one power supply line, on which the carrier element can be arranged. The electrode frame can also have a central support for holding a tubular hollow body surrounding the electrode, on which hollow body a carrier element can be arranged. It can also be provided that a tubular hollow body surrounding the electrode is associated with the electrode frame, and this hollow body at the same time is the carrier element for the bar-like element with the Hg-containing material.

Preferably, the bar-like element is additionally also provided with a getter material. In the bar-shaped element, the Hg-containing material and the getter material are therefore formed in such a way that they are mixed with one another at the same time.

In addition to adhesive bonding or welding of the bar-shaped element on the holder, it is also possible for it simply to be plugged in or clamped or latched in order to fasten it. The discharge lamp can be in the form of a fluorescent lamp or a compact fluorescent lamp.

### BRIEF DESCRIPTION OF THE DRAWINGS

Exemplary embodiments of the invention will be explained in more detail below with reference to schematic drawings, in which:

FIG. 1 shows a schematic sectional illustration of a discharge lamp according to the invention;

FIGS. 2a and 2b show a second exemplary embodiment of a carrier element according to the invention;

FIGS. 3a and 3b show a third exemplary embodiment of a carrier element according to the invention;

FIGS. 4a and 4b show a fourth exemplary embodiment of a carrier element according to the invention;

FIG. 5 shows a fifth exemplary embodiment of a carrier element according to the invention;

FIG. 6 shows a sixth exemplary embodiment of a carrier element according to the invention;

FIG. 7 shows a seventh exemplary embodiment of a carrier element according to the invention;

FIG. 8 shows an eighth exemplary embodiment of a carrier element according to the invention; and

FIG. 9 shows a ninth exemplary embodiment of a carrier element according to the invention.

### PREFERRED EMBODIMENT OF THE INVENTION

Identical or functionally identical elements have been provided with the same reference symbols in the figures.

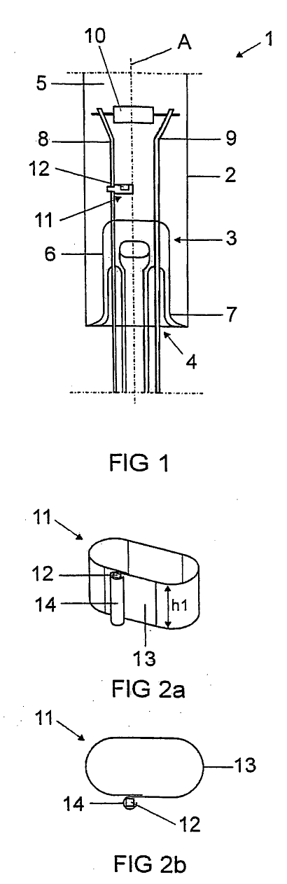

FIG. 1 shows a schematic sectional illustration of a detail of a discharge lamp 1 in the form of mercury vapor low-pressure discharge lamp. The discharge lamp 1 comprises a tubular discharge vessel 2, which can be linear, U-shaped or else bent several times. The ends of the discharge vessel 2 are filled in a gas-tight manner. An electrode frame 3 of the discharge lamp 1 extends from one end 4 of the discharge lamp 1 into the discharge space 5 formed in the interior of the discharge vessel 2. The electrode frame 3 comprises a glass plate-like stand 6, whose widened rim 7 is fused in a gas-tight manner to the end 4 of the discharge vessel 2.

Furthermore, the electrode frame 3 has two separate power supply lines 8 and 9, which are provided for holding an electrode 10 in the form of a lamp filament. Furthermore, a carrier element 11 is arranged in the discharge space 5 of the discharge lamp 1. In the embodiment shown in FIG. 1, the carrier element 11 is fastened on the power supply line 8. The carrier element 11 is illustrated schematically in FIG. 1. At least one elongate element 12 is formed on the carrier element 11, and Hg-containing material is arranged in this element. The carrier element 11 can also have a plurality of such bar-shaped elements 12, which can be designed to be geometrically identical or else different. The carrier element 11 is in the form of a metal strip and at first approximation is in the form of a type of plate.

In addition to the application of the carrier element 11 on the power supply line 8 shown in FIG. 1, it can also be provided that the carrier element 11 is fastened on the power supply line 9.

However, it can likewise also be provided that a dome (not illustrated in FIG. 1) for the electrode 10 is provided, this dome being designed as a tubular hollow body, which surrounds the electrode 10. Preferably, the horizontally running longitudinal axis (not shown in FIG. 1) of the electrode 10 and the longitudinal axis of such a dome has the same orientation. In particular, a coaxial arrangement is provided.

Given such a configuration, the carrier element 11 can at the same time represent this dome.

The dome is arranged precisely in position in particular with a linear central support (not illustrated), this central support, as an additional component to the power supply lines 8 and 9, being associated with the electrode frame 3. It can also be provided that the carrier element 11 is fastened on this mentioned central support, on which the dome is arranged.

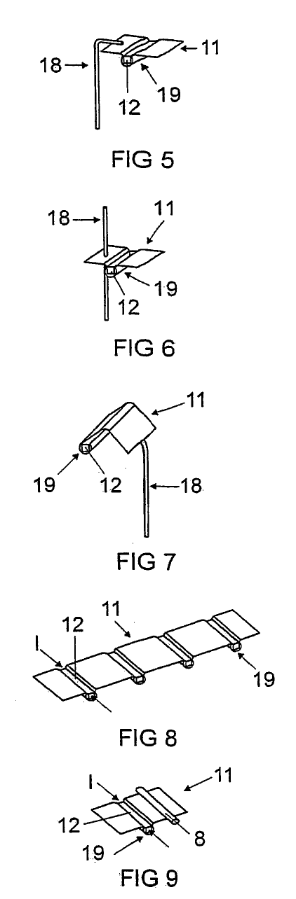

In the first exemplary embodiment shown in FIG. 1, the carrier element 11 is designed as a plate-like metal strip, and the elongate element 12, which is in the form of a piece of wire and which has both Hg-containing material and getter material, is arranged in the carrier element 11. For example, adhesive-bonding or welding of the carrier element 11 can be provided here. In particular, for example, a configuration of the carrier element 11 as is illustrated in FIGS. 5 and 6 which will be explained in more detail below, is provided.

FIG. 2a shows a perspective illustration of a second exemplary embodiment of a carrier element 11. In the illustration, the carrier element 11 is designed as a tubular hollow body, which has a flattened cross section in contrast to a round cross section. A holder in the form of a lug 14 is provided on an outer side 13, and the wire piece in the form of the elongate element 12 extends in said lug 14. The holding lug 14 has a height hi, which corresponds to the height of the outer side 13 and, in the exemplary embodiment, is also substantially the height of the element 12. In this embodiment, the bar-shaped element 12 is therefore surrounded over its entire length by the holding lug 14. The bar-shaped element 12 is in particular adhesively bonded or welded into the interior of the holding lug 14. The carrier element 11 is in particular designed to be integral with the holding lug 14, as can also be seen from the plan view illustration in FIG. 2b.

The carrier element 11 shown in the illustrations in FIGS. 2a and 2b is also provided for engaging around the electrode 10, in addition to the function of holding the bar-shaped element 12.

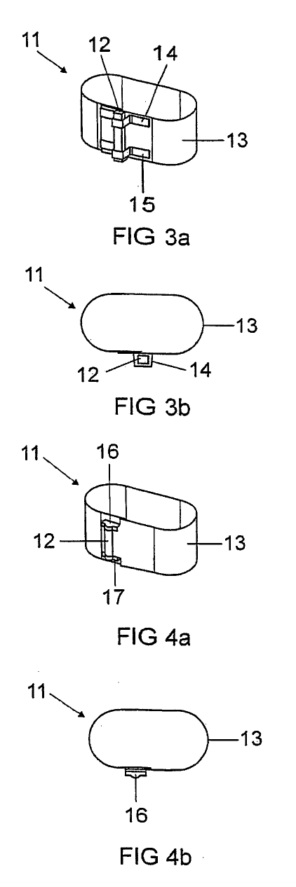

The same applies to the configurations of the carrier element 11 in FIGS. 3a, 3b and FIGS. 4a, 4b, which will be explained in more detail below.

In the perspective illustration shown in FIG. 3a, two separate holding lugs 14 and 15 are provided which hold the bar-shaped element 12 on the outer side 13. Preferably, these strip-shaped holding lugs 14 and 15 are arranged at the upper and lower end of the element 12. In this configuration, the element is therefore arranged such that it is exposed over a large part of its length. The plan view shown in FIG. 3b shows this application.

FIG. 4a shows a perspective illustration of a further embodiment of the carrier element 11 as a tubular hollow body. In this configuration, the bar-shaped element 12 has a smaller length than the height hl. Furthermore, holding lugs 16 and 17 are provided which are turned over the ends of the bar-shaped element 12 in the form of domes. The holding lugs 16 and 17 are therefore arranged quasi in the form of a cover over the upper and the lower end of the bar-shaped element 12. This is a particularly effective way of preventing the bar-shaped element from sliding out. In addition, a further fastening in the form of adhesive bonding or welding can also be provided.

FIG. 4b in turn shows a plan view of the illustration shown in FIG. 4a.

FIG. 5 shows an exemplary embodiment in which the carrier element 11 is in the form of a type of plate and has a depression 19, in which the bar-shaped element 12 is arranged. In this embodiment, the carrier element 11 is arranged on a bar-shaped central support 18, which has a bent-back section 18a at the upper end. The carrier element 11 is fastened, in particular welded, on this section 18a. The central support 18 is moreover used for holding a dome (not illustrated), which is formed separately from the carrier element 11 and represents a tubular hollow body. This tubular hollow body in the form of a dome then surrounds the electrode 10. As can be seen in the illustration shown in FIG. 5, the depression 19 has a breadth and a width such that the bar-shaped element 12 finds space directly therein.

FIG. 6 shows a perspective illustration of a further exemplary embodiment, with the carrier element 11 with the bar-shaped element 12 being arranged approximately at the height of the center of the central support 18 there, in contrast to the configuration shown in FIG. 5. Furthermore, a dome (as already explained in relation to FIG. 5) for engaging around the electrode 10 can be applied to the central support 18.

FIG. 7 shows a further exemplary embodiment in a perspective illustration, the carrier element 11 being designed as an angled plate. At its front end, in turn a depression 19 is designed in the form of a bent-back portion of the plate-like part, with the bar-shaped element 12 being arranged therein. In this case, too, the central support 18 is also provided for holding a dome (as explained above) in addition to holding the carrier element 11.

Such a central support 18 in accordance with the embodiments in FIGS. 5 to 7 is provided in addition to the power supply lines 8 and 9 and is associated with the electrode frame 3.

FIG. 8 shows an exemplary illustration of a carrier element 11, which comprises a plurality of bar-shaped elements 12. These are each arranged in a depression 19 of the plate-like carrier element 11 and are positioned spaced apart from one another and substantially parallel to one another. The length 1 of the element 12 is substantially the same.

In all exemplary embodiments shown in FIGS. 1 to 8, the elongate element 12 has a mercury concentration of 0.46 mg per millimeter of length and is in the form of a wire.

FIG. 9 shows a perspective illustration of a carrier element 11 welded on a power supply line 8. The power supply line 8 in this case runs substantially parallel to the element 12 and is arranged on the upper side of the carrier element to the side of the depression 19. In the exemplary embodiment, two welded joints for fastening purposes are provided, it being possible for there to be several of these welded joints or for welding to take place along the entire length.

1. A carrier element on which an Hg-containing material for application in a discharge lamp (1) is formed, characterized in that the Hg-containing material is in the form of a bar-shaped element (12) and is arranged on a holder (14, 15, 16, 17; 19) of the carrier element (11).

2. The carrier element as claimed in claim 1, characterized in that the bar-shaped element (12) has a defined quantity of Hg per unit length, and the quantity of Hg to be applied specifically to the carrier element (11) can be metered depending on the length (1) of the element (12).

3. The carrier element as claimed in claim 1, characterized in that the bar-shaped element (12) has approximately 0.46 mg of Hg per mm.

4. The carrier element as claimed in claim 1, characterized in that the carrier element (11) has, as the holder, at least one depression (19), in which the element (12) is arranged.

5. The carrier element as claimed in claim 1, characterized in that the carrier element (11) is in the form of a type of plate.

6. The carrier element as claimed in claim 1, characterized in that the carrier element (11) is a tubular hollow body.

7. The carrier element as claimed in claim 6, characterized in that at least one holding lug (14 to 17) for holding the element (12) is formed as a holder on the outer side (13) of the hollow body.

8. The carrier element as claimed in claim 7, characterized in that the bar-shaped element (12) is adhesively bonded, clamped or welded into the holding lug (14 to 17).

9. The carrier element as claimed in claim 7, characterized in that the holding lug (14 to 17) extends substantially over the entire length (1) of the element (12).

10. The carrier element as claimed in claim 6, characterized in that the tubular hollow body surrounds an electrode (10) arranged in the discharge vessel (2) of the discharge lamp (1).

11. The carrier element as claimed in claim 1, characterized in that it is arranged on a power supply line (8, 9) for an electrode (10).

12. The carrier element as claimed in claim 1, characterized in that it is arranged on a central support (18), which is associated with an electrode frame (3) and is designed to hold a tubular hollow body surrounding the electrode (10).

13. The carrier element as claimed in claim 1, characterized in that it is in the form of a metal strip.

14. The carrier element as claimed in claim 1, characterized in that the bar-shaped element (12) has a sheath and a core and the Hg is contained in the core.

15. A discharge lamp with a discharge vessel (2) and at least one electrode (10) arranged therein, and with a carrier element (11) as claimed in claim 1 which is arranged in the discharge vessel (2).

16. The discharge lamp as claimed in claim 15, characterized in that the carrier element (11) is arranged on an electrode frame (3), in particular a power supply line (8, 9) or a central support (18), or is a tubular hollow body, which surrounds the electrode (10) and is associated with the electrode frame (3).

17. The carrier element as claimed in claim 2, characterized in that the bar-shaped element (12) has approximately 0.46 mg of Hg per mm.
